(19) United States
(12) Patent Application Publication
(10) Pub. No.: US 2021/0096809 A1
(43) Pub. Date: Apr. 1, 2021

(54) TRIP-BASED INTELLIGENT MEDIA CONTROLS

(71) Applicant: Ford Global Technologies, LLC, Dearborn, MI (US)

(72) Inventor: Jason Woo, Northville, MI (US)

(73) Assignee: Ford Global Technologies, LLC, Dearborn, MI (US)

(21) Appl. No.: 16/589,859

(22) Filed: Oct. 1, 2019

(51) Int. Cl. G06F 3/16; G05B 15/02; G01C 21/36

(52) U.S. Cl. CPC G06F 3/165; G01C 21/3697; G05B 15/02

(57) ABSTRACT

Trip-based intelligent media controls are provided herein. An example method includes determining a remaining trip time for a vehicle, selecting media for a user of the vehicle based on the remaining trip time, the media having a playback time that is approximately equal to the remaining trip time, and providing the media to the user.

### TECHNICAL FIELD

The present disclosure relates to media delivery, and more particularly, to systems and methods that provide for trip-based intelligent media controls for in-vehicle entertainment systems.

### BACKGROUND

Media is typically played in vehicles. Some examples of media include songs, talk shows, or podcasts. When drivers consume media during a trip, it is inconvenient when the trip is completed before the entertainment is completed because it forces the customer to either relinquish completing the remainder of the entertainment or it forces them to pause and wait for the next listening opportunity to resume. Often times, the next listening opportunity is not until the next vehicle trip, which can be for extended periods.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a flowchart of an example method of the present disclosure.

FIG. 3 is a flowchart of another example method of the present disclosure.

### DETAILED DESCRIPTION

### Overview

The systems and methods disclosed herein may provide intelligent entertainment delivery based on trip time. In some instances, an entertainment system of the present disclosure can determine a trip duration using various input(s). For example, trip duration can be calculated based on historical driving behavior, or in some instances, user input received through a navigation system of the vehicle. In various embodiments, trip duration can be periodically or continually evaluated. For example, periodic recalculation of trip time can indicate changes in trip duration due to traffic, accidents, or other similar events. In various embodiments, historical driving behavior can be accessed from a cloud-based service provider.

When the trip duration is known, media can be selected for delivery to a user within the vehicle. The media can be selected based on a playback time that is approximately equal to the trip duration. The media can further be filtered according to user preferences. The media can include a single media file or a plurality of media files concatenated or aggregated together so as to have a playback time that is approximately equal to the trip duration. In another example, a larger single media file can be subdivided into a plurality of plurality of media files based on one or more the trip durations. For example, if a user is known to drive the same or similar trip duration each morning to work, a single media file can be subdivided into segments that can be played over a series of trips in one day or over several days during the entirety of each trip.

As noted above, periodic or continual recalculation of trip duration (e.g., remaining trip time) may result in changes to a current trip-based playlist. For example, when it is determined that the trip duration has changed, the trip-based playlist can be altered by adding or removing media files.

### Illustrative Embodiments

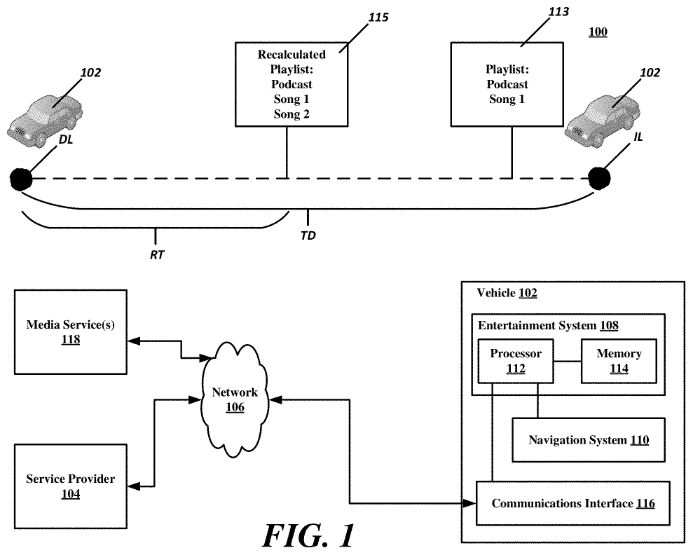

Turning now to the drawings, FIG. 1 depicts an illustrative architecture 100 in which techniques and structures of the present disclosure may be implemented. The illustrative architecture 100 may include a vehicle 102, a service provider 104, and a network 106. The network 106 may include any one or a combination of multiple different types of networks, such as cable networks, the Internet, wireless networks, and other private and/or public networks. In some instances, the network 106 may include cellular, Wi-Fi, or Wi-Fi direct.

In general, the vehicle 102 can include at least an entertainment system 108 and a navigation system 110. In some embodiments, the entertainment system 108 may comprise a processor 112 and memory 114. The memory 114 stores instructions that are executed by the processor 112 to perform aspects trip or time-based media selection and playback as disclosed throughout. When referring to operations executed by the entertainment system 108 it will be understood that this includes the execution of instructions by the processor 112. While an entertainment system will be referenced throughout, it will be understood that the features of the present disclosure can be executed by any suitable vehicle-based human machine interface that would be known to one of ordinary skill in the art. In some embodiments, the vehicle 102 can also include a communications interface 116 that allows the processor 112 of the entertainment system 108 to access the network 106 and communicate with the service provider 104, as will be discussed in greater detail herein.

In some embodiments, the processor 112 of the entertainment system 108 can maintain or otherwise access a preference profile for a user of the vehicle 102. The preference profile may include information that is indicative of media preferences of the user, such as music genres, bands, and so forth. In some embodiments, the preference profile can be based on historic media usage by the user. The preference profile can also include information that is indicative of subscriptions to services such as podcasts. As noted above, the preference profile of the user can be stored and maintained locally at the vehicle level. Alternatively, the preference profile of the user can be stored and maintained remotely at the service provider level. The entertainment system 108 can locally store or access media files for playback or access the media files through the network 106 from one or more media services 118 (e.g., streaming services) or through the service provider 104. The entertainment system 108 can provide any desired media file that is accessible to the user of the vehicle 102 such as music, video, podcast, and the like.

In various embodiments, the processor 112 of the entertainment system 108 can receive a calculated trip duration from the navigation system 110 or the service provider 104. For example, the navigation system 110 can be configured to calculate or estimate trip duration based on routine trip machine learning. In one embodiment, the navigation system 110 can be configured to learn historical driving patterns of the user. In one non-limiting example, the navigation system 110 learns that the user travels approximately 25 minutes to work each day Monday through Friday. In another embodiment, the navigation system 110 can determine a trip duration based on input received into the navigation system 110. For example, the user can enter a destination location. Based on a known location IL of the vehicle 102 and the inputted destination DL, the navigation system 110 can calculate the trip duration. The trip duration TD may be defined as the total time it takes for the vehicle 102 to travel to DL from IL. A remaining time RT is equivalent to the time it takes for the vehicle 102 to arrive at DL from any given point between IL and DL. Initially, remaining time RT is equivalent to the initial trip duration TD that was calculated. As will be discussed in greater detail infra, the remaining time RT can be periodically recalculated and is indicative of changes to the trip duration based on intervening events such as traffic, weather, and so forth, which may impact drive time. Corresponding changes to media selection may occur in response to changes in remaining time RT.

In sum, a determination a trip duration can include the determination of a destination for the vehicle from historical driving behavior or input received through a navigation system of the vehicle. Further, the trip duration can be calculated based on the destination and a current location of the vehicle. In a further refinement, a remaining time can be based on dynamic recalculations during drive time.

Regardless of the methodology used to calculate the trip duration, once the trip duration is determined, the processor 112 of the entertainment system 108 can identify media to be provided to a user of the vehicle 102. In various embodiments the media has a total playback time that is approximately equal to the trip duration. Stated otherwise, the processor 112 of the entertainment system 108 creates a playlist or queue that includes one or more media files that have a playback time that is approximately equal to the trip duration. It will be understood this approximation can be based on a range or percentage of value of the trip duration. For example, if the trip duration is 25 minutes, the playback time could be +/−two percent of 25 minutes or 25.5 minutes or 24.5 minutes. To be sure, the predetermined percentage used can vary as desired and can be selected by a user in some instances. In various embodiments, the processor 112 of the entertainment system 108 may select media file(s) having a playback time that is at least less than the trip duration by a predetermined percentage and may exclude media file(s) having a playback time that exceeds the trip duration. As illustrated in FIG. 1, a playlist 113 is created that includes a podcast and a song. These media were curated into a queue based on the calculated trip duration.

In some embodiments, the processor 112 of the entertainment system 108 can obtain a single media file, such as a podcast having a playback time of approximately 25 minutes. In another embodiment, the processor 112 of the entertainment system 108 can obtain a plurality of media files such as a plurality of songs and generate a playlist or queue. For example, the processor 112 of the entertainment system 108 can create a playlist with a first song having a playback time of 6:20 minutes, a second song having a playback time of 7:30 minutes, a third song having a playback time of 5:30 minutes, a fourth song having a playback time of 5:20 minutes, for a total of 24:40 minutes. In general, the media selected by the processor 112 of the entertainment system 108 may include a plurality of media files, where each of the plurality of media files has an individual playback time. The collectively playback times of the plurality of media files equal the collective playback time that is approximately equal to the trip duration. That is, the processor 112 of the entertainment system 108 may determine a total playback time for media that is provided to the user during the trip duration. The total playback time of the media can correspond to a single media file, such as a podcast having an individual playback time that is approximately equal to the trip duration. The total playback time of the media can correspond to a plurality of media files, such as multiple songs. Each of the songs has an individual playback time. The playback times of the plurality of media files collectively sum to be approximately equal to the trip duration. Stated otherwise, completion of playback of the last media file in the queue should occur approximately when the vehicle 102 arrives at its destination.

In various embodiments, the processor 112 of the entertainment system 108 can provide selective filtering of media files based on either or both of playback time and/or user preference. For example, the processor 112 of the entertainment system 108 can exclude media options that do not correspond to the preferences of the user, as well as excluding media options having a playback time that would not approximately correspond to the trip duration. Stated otherwise, the media to be provided to the user of the vehicle may include preferred media that has been further filtered based on a playback time that is within a predetermine percentage of the trip duration.

It should be understood that user preferences as disclosed herein are not limited to media genre selections (i.e., genre, artist, podcast topics, etc.) but may also include preferences on how classification of the media options are recommended to a user (i.e., for podcasts whose duration is not evenly divisible by trip duration, the user may prefer the system to rank it lower in queue of recommendations rather than other media types. An example ranking of media types based on user preference can include categories and classification of podcasts (an example of order of preferences where the first selection is most preferred by the user): (1) a single podcast whose play duration approximately equals the trip duration; (2) multiple podcasts whose sum duration approximately equals the trip duration; (3) a single podcast having a play duration may be evenly divisible by trip duration (e.g., no gaps); (4) a single podcast having a play duration that is not evenly divisible by trip duration, and add a few songs to fill remaining gaps; and (5) a single podcast having a play duration that is not evenly divisible by trip duration, with nothing to fill remaining gaps.

According to some embodiments, the processor 112 of the entertainment system 108 can determine that a media file has a playback time that exceeds the trip duration. In various embodiments, the processor 112 of the entertainment system 108 can determine if that media file can be divided into portions. If so, the processor 112 of the entertainment system 108 can divide that media file into portions based on the trip duration. In some instances, the portions are played sequentially over a plurality of trips.

In one example embodiment, a podcast is identified to have a playback time of 74:50 minutes. The processor 112 of the entertainment system 108 can divide the podcast into portion: a first portion having a playback time of 24:50 minutes, a second portion having a playback time of 25:40 minutes, and a third portion having a playback time of 25:20 minutes. In general, the processor 112 of the entertainment system 108 can determine longer media selections that can be approximately evenly divided into plurality of trips so that completion is aligned (or roughly aligned) with each of the trip durations.

In various embodiments, when a media file is subdivided, a last portion may not have a playback time that is approximately equal to the trip duration. For example, the processor 112 of the entertainment system 108 can divide the podcast into portion: a first portion having a playback time of 24:50 minutes, a second portion having a playback time of 25:40 minutes, and a third portion having a playback time of 20:20 minutes. This would leave a gap of approximately five minutes. The processor 112 of the entertainment system 108 could select a song from a playlist to fill in this gap, or lower its queue ranking in its recommendations list.

In general, the processor 112 of the entertainment system 108 can identify when one or more of the portions do not approximately equal the trip duration, and select additional media to combine with the one or more of the portions. To be sure, the playback time of the one or more of the portions and the additional media approximately equal the trip duration (or a remaining trip time).

As noted above, the processor 112 of the entertainment system 108 may be configured to periodically or continually reevaluate a current playlist based on a periodic or continual reassessment of the trip duration by the navigation system 110 (or the service provider 104). Thus, the navigation system 110 can determine a trip duration or remaining trip time in a dynamic manner. For example, if the vehicle 102 encounters heavy traffic, the remaining trip time may increase significantly. In one embodiment, using the example provided above, the navigation system 110 identified an initial trip duration of 25 minutes based on historical driving behaviors. The processor 112 of the entertainment system 108 had previously divided a podcast into a plurality of portions. One of these portions is being provided by the entertainment system 108 during a commute. As the vehicle encounters heavy traffic, the navigation system 110 determines that the remaining trip time has increased the trip duration from 25 minutes to 35 minutes. For example, the vehicle 102 encounters heavy traffic at minute 20 of the original 25 minute trip duration. Thus, the new or updated trip duration is 35 minutes, with a remaining trip time of fifteen minutes. The processor 112 of the entertainment system 108 receives the updated remaining trip time and identifies when the playback time of the media is no longer approximately equal to the remaining trip time. When this discrepancy is identified by the processor 112 of the entertainment system 108, additional can be selected and combined with the one or more of the portions. To be sure, the playback time of the one or more of the portions and the additional media approximately equal the trip duration. In the example above, the processor 112 of the entertainment system 108 may select one or more songs to fill in this 15 minute gap. For example, in FIG. 1, a recalculated playlist 115 includes a podcast, a first song, and a second song. Thus, a second song has been added to the playlist 113 originally created.

In sum, the navigation system 110 (or service provider 104) can periodically recalculate the remaining trip time. The processor 112 of the entertainment system 108 may identify when the playback time of the media is no longer approximately equal to the remaining trip time, and then reselect the media such that the playback time is approximately equal to the remaining trip time. To be sure, the reselection can include adding additional media files to a queue to fill a time gap when the remaining trip time increases during a trip. The processor 112 of the entertainment system 108 could also suggest to a user that a currently selected media file will not be complete at arrival of the destination based on a recalculated remaining trip time. For example, during travel the navigation system 110 determines that the remaining trip time has decreased. The processor 112 of the entertainment system 108 determines that the media currently being played cannot be completed. The processor 112 of the entertainment system 108 can suggest that the user could switch to a music playlist. If selected, the processor 112 of the entertainment system 108 can create a music playlist or queue based on the remaining trip time and save the original media for a subsequent trip.

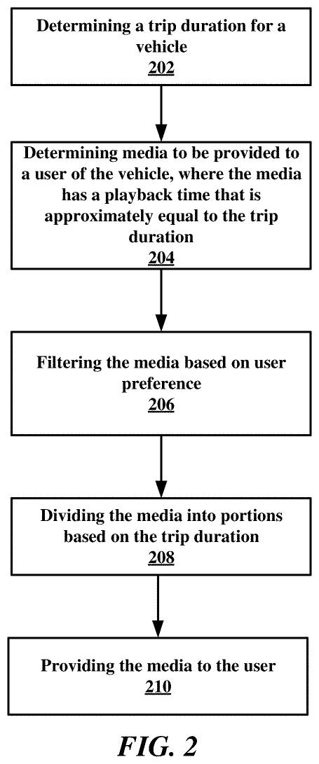

FIG. 2 is a flowchart of an example method of the present disclosure. The method generally includes a step 202 of determining a trip duration for a vehicle. As noted above, this process can occur using a navigation system of a vehicle or through using a navigation service provided through a cloud-based service provider. The trip duration can be determined using a current location and destination location, as well as other data such as traffic and weather. Next, the method includes a step 204 of determining media to be provided to a user of the vehicle, where the media has a playback time that is approximately equal to the trip duration. In various embodiments, the method can include an optional step 206 of filtering the media based on user preference. Again, this can include selecting media of a particular preferred genre, type, style, or according to a subscription service.

According to some embodiments, the method can include an optional step 208 of dividing the media into portions based on the trip duration. As noted above, this could include dividing a large podcast into several portions for playback over several trips. The method can also include a step 210 of providing the media to the user.

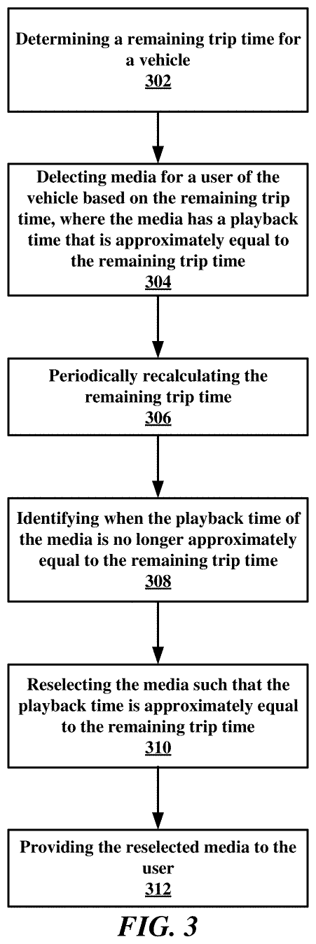

FIG. 3 is a flowchart of another example method of the present disclosure. The method includes a step 302 of determining a remaining trip time for a vehicle. In some embodiments, this step is a periodic or continual process executed by a navigation system of a vehicle or through using a navigation service provided through a cloud-based service provider. The remaining trip time may be dynamic, either shortening or lengthening based on current drive-time assessment. The method includes a step 304 of selecting media for a user of the vehicle based on the remaining trip time, where the media has a playback time that is approximately equal to the remaining trip time.

Due to the dynamic nature of drive-time, the method can include a step 306 of periodically recalculating the remaining trip time, as well as a step 308 of identifying when the playback time of the media is no longer approximately equal to the remaining trip time. When this determination is made, the method can include a step 310 of reselecting the media such that the playback time is approximately equal to the remaining trip time. The reselected media can be provided to the user in step 312. To be sure, originally selected media can be provided initially after step 304 where originally selected media is determined. The reselected media could include the originally selected media plus additional media to fill in a gap. For example the originally selected media has a fifteen minute duration and was selected based on an initial trip duration calculation of fifteen minutes. Subsequent recalculation determines that remaining trip time has increased so that the total trip duration is twenty minutes rather than fifteen minutes, the reselected media could include the originally selected media plus additional media to fill the five minute gap.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that stores computer-executable instructions is computer storage media (devices). Computer-readable media that carries computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method, comprising:
determining a trip duration for a vehicle;
determining media to provide to a user of the vehicle, the media having a playback time that is approximately equal to the trip duration; and
providing the media to the user.

2. The method according to claim 1, wherein determining the trip duration for the vehicle comprises:
determining a destination for the vehicle from historical driving behavior or input received through a navigation system of the vehicle; and
calculating the trip duration based on the destination and a current location of the vehicle.

3. The method according to claim 1, wherein the media includes a plurality of media files, and wherein the plurality of media files equal the playback time.

4. The method according to claim 3, further comprising selecting the plurality of media files such that the playback time of each of the plurality of media files collectively sums to be approximately equal to the trip duration.

5. The method according to claim 1, further comprising filtering the media according to user preferences for the user to determine preferred media.

6. The method according to claim 5, wherein determining the media to be provided to the user of the vehicle comprises filtering the preferred media having a playback time that is within a predetermine percentage of the trip duration.

7. The method according to claim 1, further comprising dividing the media into portions based on the trip duration, wherein the portions are played sequentially over a plurality of trips.

8. The method according to claim 7, further comprising:
identifying when one or more of the portions do not approximately equal the trip duration; and
selecting additional media to combine with the one or more of the portions such that the playback time of the one or more of the portions and the additional media approximately equal the trip duration.

9. A system, comprising:
a processor; and
a memory for storing executable instructions, the processor executing the instructions to:
determine a trip duration or remaining trip time for a vehicle;
determine media to provide to a user of the vehicle, the media having a total playback time that is approximately equal to the trip duration or the remaining trip time; and
provide the media to the user.

10. The system according to claim 9, further comprising
a service provider that is configured to determine a destination for the vehicle from historical driving behavior, wherein the processor is configured to calculate the trip duration based on the destination and a current location of the vehicle, the system obtaining the trip duration from the service provider over a network.

11. The system according to claim 9, wherein the media includes a plurality of media files, wherein the plurality of media files equal the total playback time.

12. The system according to claim 11, wherein the processor executes the instructions to select the plurality of media files such that playback times of the plurality of media files collectively sums to be approximately equal to the trip duration.

13. The system according to claim 9, wherein the processor executes the instructions to filter the media according to user preferences for the user to determine preferred media.

14. The system according to claim 13, wherein processor executes the instructions to filter the preferred media having a playback time that is within a predetermine percentage of the trip duration.

15. The system according to claim 9, wherein the processor executes the instructions to divide the media into portions based on the trip duration, wherein the portions are played sequentially over a plurality of trips.

16. The system according to claim 15, wherein the processor executes the instructions to:
identify when one or more of the portions do not approximately equal the trip duration; and
select additional media to combine with the one or more of the portions such that the playback time of the one or more of the portions and the additional media approximately equal the trip duration.

17. A method, comprising:
determining a remaining trip time for a vehicle;
selecting media for a user of the vehicle based on the remaining trip time, the media having a playback time that is approximately equal to the remaining trip time; and
providing the media to the user.

18. The method according to claim 17, further comprising:
periodically recalculating the remaining trip time;
identifying when the playback time of the media is no longer approximately equal to the remaining trip time; and
reselecting the media such that the playback time is approximately equal to the remaining trip time.

19. The method according to claim 17, further comprising filtering the media according to user preferences for the user to determine preferred media.

20. The method according to claim 17, further comprising dividing the media into portions based on the remaining trip time, wherein the portions are played sequentially over a plurality of trips.
